(19) United States
(12) Patent Application Publication
(10) Pub. No.: US 2023/0069995 A1
(43) Pub. Date: Mar. 9, 2023

(54) OIL FILTER HOUSING

(71) Applicant: Polaris Industries Inc., Medina, MN (US)

(72) Inventor: Broderick Valin Bjorkquist, Roseau, MN (US)

(21) Appl. No.: 17/902,131

(22) Filed: Sep. 2, 2022

Related U.S. Application Data
(60) Provisional application No. 63/241,490, filed on Sep. 7, 2021.

(51) Int. Cl. B01D 27/08; B01D 27/10

(52) U.S. Cl. CPC B01D 27/08; B01D 27/106; B01D 2271/02

(57) ABSTRACT

An engine includes a filter housing with a base and a housing cover that contain a filter cartridge. The base defining a central recess, and having an annular sump extending downwardly from the central recess. An inwardly facing cylindrical sealing surface partially defining the annular sump, a drainage port defined in the cylindrical sealing surface and extending radially outward therefrom. The housing cover with a closed upper end and a downwardly extending annular wall sized to extend into the sump, the annular wall having a pair of seals that, when the housing cover is fully seated with the base provides a seal above the drainage port and a seal below the drainage port, the pair of seals precluding entry of oil into the drainage port when the housing cover is fully seated; whereby when the housing cover is raised upwardly, the lower seal is raised above the drainage port and oil in the filter housing drains out the drainage port.

This application claims priority to U.S. Provisional Application No. 63/241,490 filed on Sep. 7, 2021, the contents of said application incorporated by reference herein.

### BACKGROUND OF THE INVENTION

Vehicles with internal combustion engines have crankcases with lubricating oil and oil filters. The oil and filters need to be regularly changed. The filters may be in canisters integrated with the filters and exteriorly exposed on the engine such that removal is accomplished by simply unscrewing the filter and canister. The removal inevitably results in oil leaking from the oil port when the canister is removed. Some internal combustion engines utilize oil filters contained in filter housings attached to the engine crankcase. In such, arrangements, the filter housing and filter therein are typically full of oil and removal of the housing cover, and the saturated filter, typically spills a significant amount of oil on the engine and floor or ground below. The degree of the spillage may depend on the orientation and positioning of the housing and various other factors.

Designs that allow oil to drain from oil filter housings as the filter housing cover is removed have been attempted. Some of these have active valves members that may be conducive to clogging, other designs have axially compressed seals that are not readily accessible for cleaning or replacement, and that require a close tolerances in manufacturing, tightening, and sealing. See U.S. Pat. No. 5,698,098. Other known designs utilize elongate central valve members that extend down into a centralized drainage port with seals on the drainage port. Such arrangements require removal of the elongate valve member when changing oil, which when removed will drip oil collected in and on the elongate valve member. Additionally, adding a central oil drainage conduit in the engine crankcase may be problematic in many engine designs. Improvements and simplifications in manufacturing, design, and robustness of designs would be well received by the industry.

Internal combustion engines in powersport environments, such as off-road recreational vehicles, may need more frequent oil changes that road based vehicles. Such changing of the oil and filters is often performed by vehicle owners. Any simplification of the task, reduction of the associated mess, and reduction in costs of components would be well received by powersport consumers.

### SUMMARY OF THE INVENTION

An internal combustion engine with a filtered circulating oil system with an oil cartridge housing having an upwardly facing housing base and a filter housing cover that threadingly attaches to a base that is integrated with or unitary with the engine crankcase. The housing cover and base defining an oil filter receiving region with the filter cartridge contained therein. The base has two primary oil circulating passages and a third passage for gravity draining of oil from the oil filter receiving region during maintenance when the engine is not running and the filter housing cover is loosened from the base. The base having an upper cylindrical recess with a threaded portion, a cylindrical sealing surface above the threaded portion, a lower filter seating pedestal with an axially facing filter sealing surface and one or more primary oil ports positioned radially exterior of the filter seating/sealing surface and the filter. The one or more primary oil ports connecting to a primary oil circulating passageway. Centrally positioned on the pedestal, a projecting male filter connector sized to receive the filter at the central aperture of the filter, the male filter connector having one or more primary oil circulating ports. The central pedestal defined by an annular sump extending downward from the upper cylindrical recess and positioned below the filter and the filter seating/sealing surface, the annular sump having an inwardly facing cylindrical sealing surface with a third port of a third passageway for draining oil received in the annular sump. The third passageway ultimately extending to the engine crankcase. The housing cover generally being shaped as an inverted cup with an upper end portion, with a drive portion that may be configured as a hex or square drive, is centrally located thereon and a filter engaging projection extending centrally and axially from the upper end portion in the interior of the housing cover. Joining the upper end portion is the sidewall of the housing cover including an upper sidewall portion with an upper cylindrical exterior surface with a circumferential upper seal groove therein, a seal in the upper seal groove, a mid sidewall portion below the upper portion with external threads for engaging with the base threads, and a lower sidewall portion with a lower cylindrical exterior surface having a pair of circumferential lower seal grooves. A respective pair of lower seals positioned in the lower seal grooves. The lowest of the lower seal grooves and the seal therein are positioned to be axially below the third passageway above in the annular sump when the housing cover is fully in place. The upper of the lower seal grooves and the seal therein are positioned axially above the third passageway when the housing cover is fully in place.

The base of the housing may have an attachment face for interfacing with a cooperating attachment face on the crankcase with a conventional seals, gaskets and bolts, or may be integrated with, that is, unitary with the crankcase or a portion of the crankcase.

A feature and advantage of embodiments is that changing oil is less messy than utilizing prior art systems.

A feature and advantage of embodiments is the filter housing is relatively easy to manufacture with minimal components, and the components needed, specifically seals, are conventional.

A feature and advantage of embodiments is that drainage of an oil filter housing occurs during the removal of the oil filter housing without the utilization of active valves such as valves having a valve member that engages a valve seat, nor valves with a spring, rather a drainage port opens when the housing is partially removed and a radially compressed annular seal moves out of a blocking position.

A feature and advantage of embodiments is that the filter housing has an upright axis with a base including an annular wall with a margin that is above the primary oil passageways such that when the oil drainage port opens oil level in the filter housing drops below the margin.

A feature and advantage of embodiments is that a radially compressed annular seal on the filter housing cover isolates or blocks the oil drainage port from an oil circulating region, and when the housing cover is loosened by rotation, the oil drainage port transitions to an unblocked and non-isolated status connecting the oil circulating region to the oil drainage port.

A feature and advantage of embodiments is that the seals above and below the drainage port in the base sump are not axially compressed to accomplish the respective seals. Moreover, the seals are readily available and replaceable, being on the exterior of the housing cover where they may be inspected and cleaned with the removal of the housing cover from the base.

A feature and advantage of embodiments is that the relative shallow depth of the base allows inspection and cleaning of the base sump when changing oil.

### DESCRIPTION OF THE FIGURES

FIG. 1 is elevational view of an internal combustion engine suitable for an off road vehicle having an oil filter housing.

FIG. 2 is a front perspective view of oil filter housing in accord with embodiments.

FIG. 3, is a side perspective view of the oil filter housing of FIG. 2.

FIG. 4 is a rear perspective view of the oil filter housing of FIGS. 2-3.

FIG. 5 is a top rear perspective view of the oil filter housing of FIGS. 2-4.

FIG. 6 is an exploded view of the components of the oil filter housing of FIGS. 2-5.

FIG. 7 is another exploded view of the components of the oil filter housing of FIGS. 2-5.

FIG. 8 is a perspective view of the housing cover showing the interior of the cover.

FIG. 9 is a perspective view of the base illustrating the pedestal and oil ports.

FIG. 10 is a cross sectional view of the assembled oil filter housing with a filter therein.

FIGS. 11A, 11B, and 11C are cross sectional views similar to FIG. 10 illustrating the draining action through the base sump and third port as the housing cover is raised.

### DETAILED DESCRIPTION

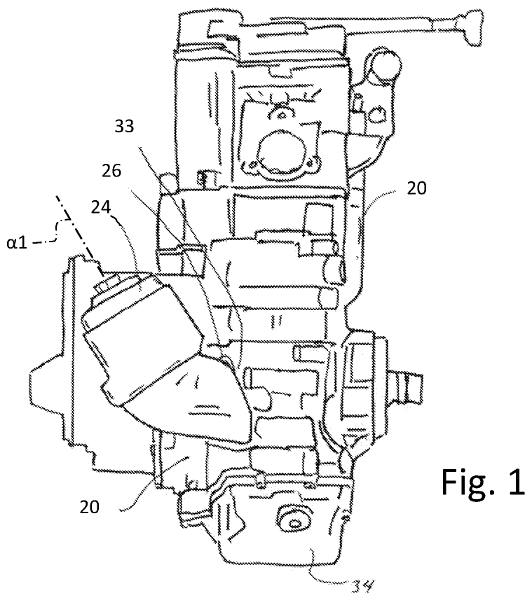

Referring to FIG. 1, an engine 20 suitable for recreational vehicles such as off road vehicles is illustrated, generally has an circulating oil system with a self-draining filter housing assembly 24. The filter housing assembly is attached by way of a flange 26 that bolts to the engine crankcase 32 at a conforming surface 33. The circulating oil system includes a crankcase oil sump 34. The entirety of the filter housing assembly is positioned above the oil sump whereby when the engine is not running and when there is a drainage pathway, oil will drain by gravity from the filter housing assembly to the oil sump. The filter housing assembly has an upright axis al, with the axis more vertical than horizontal.

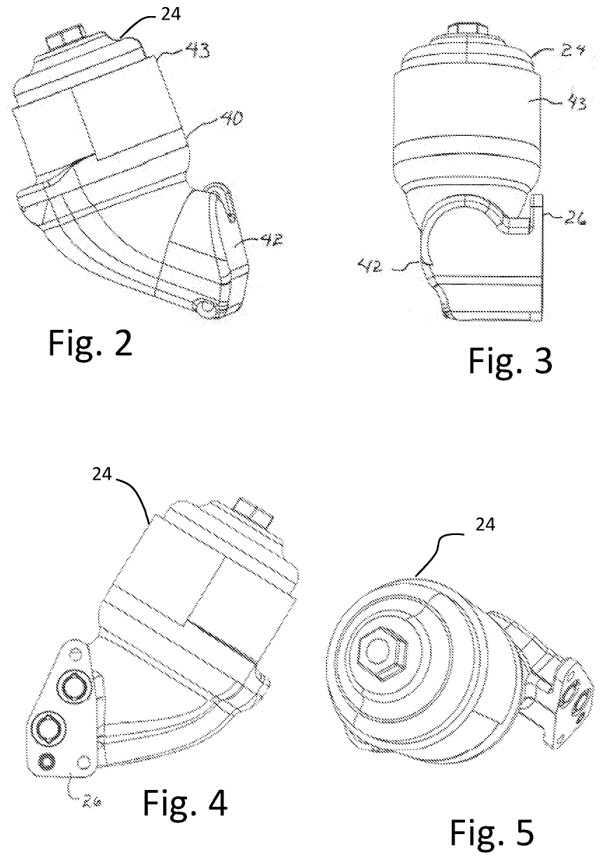

Referring to FIGS. 2-10, the filter housing assembly 24 comprises a filter housing 40 with a base 42 and a filter housing cover 43 that cooperates to define a filter cartridge receiving region 46 and an oil circulating region 47. A replaceable filter cartridge 48 is received therein and engages internal structure, described below, on both the base 42 and the filter housing cover 43 that sealingly secure the filter cartridge in place. The filter cartridge may be conventional with folded filter media 49 secured between rigid polymer or elastomeric end caps 51, 52. A central axially extending aperture 53 extends the axial length of the filter cartridge. The axis of the filter cartridge, including the aperture 53 is coaxial with the filter housing axis al.

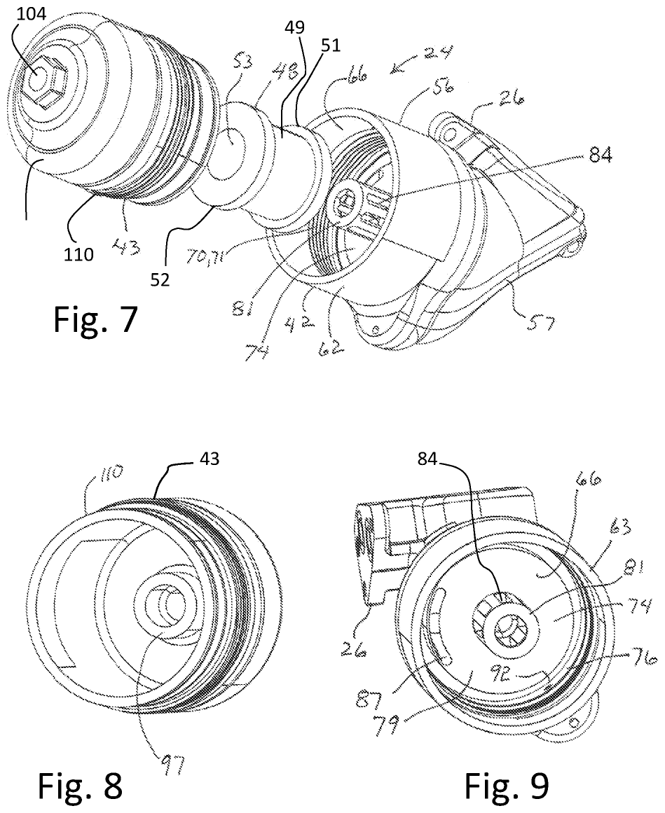

As best seen in FIGS. 7, 9, and 10, the filter housing base 42 has an upper portion 56 and a lower portion 57. The upper portion having an upper collar 62 with annular wall 63 with a generally cylindrical exterior surface 64 and an upper wall margin 65. The upper collar defining a central recess 66 that receives both the filter housing cover 43 and the filter cartridge 48 and further defines a. The upper collar annular wall 63 having an interiorly facing surface 68 that includes an uppermost cylindrical sealing surface 69 and a threaded portion 70 with threads 71 therebelow. The base central recess 66 is partially defined by a pedestal 74 projecting upwardly, the pedestal 74 defined by an annular recess that forms an annular sump 76 in the base portion. The annular sump having an axis coaxial with the axis al of the filter housing. The pedestal having an upwardly facing filter cartridge engaging surface 79 and a male filter cartridge engaging ported projection 81 sized for being snuggly received in the central aperture 53 of the filter cartridge. The ported projection having a first primary oil port 84 that connects to a first primary oil circulating passageway 85 that extends through the lower portion 57 of the base 42 to the flange 26. The upper surface 79 of the pedestal also having a second primary oil port 87 that may be arcuate shaped that connects to second primary oil circulating passageway 89 that extends through the lower portion 57 of the base 42 to the flange 26.

The base has a third port 92 that is positioned in the annular sump 76 connecting to a third drain passageway 94 that also extends through the lower portion 57 of the base 42 to the flange 26. The third port 92 is positioned on an inwardly facing cylindrical sealing surface 94 in the sump.

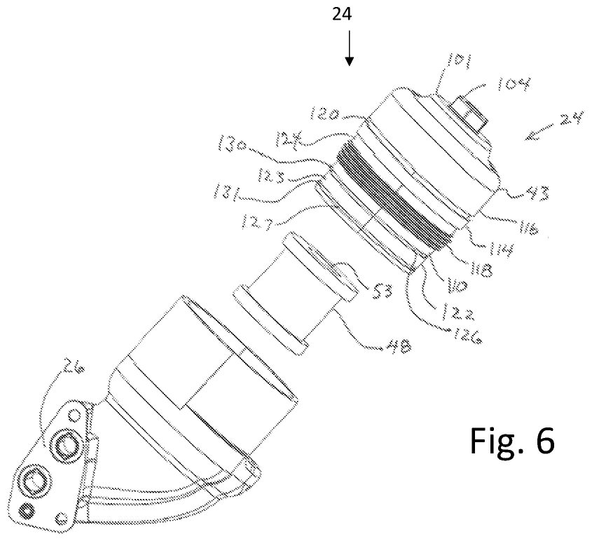

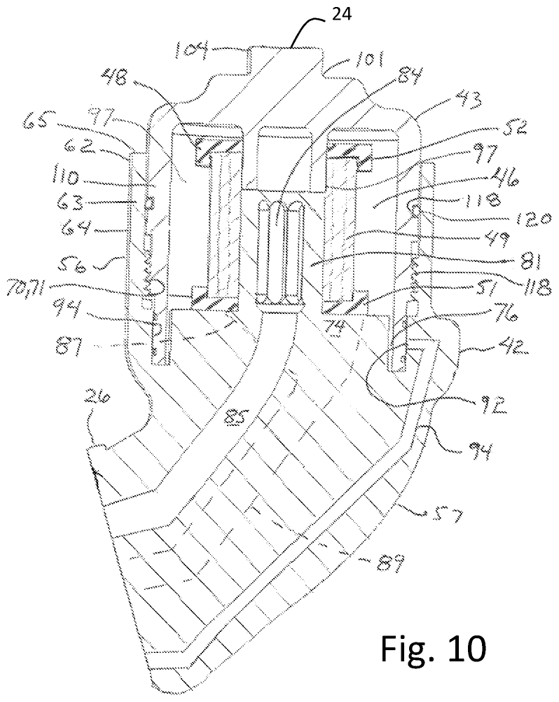

As best seen in FIGS. 8 and 10, the housing cover 43 has a downwardly extending central filter engaging projection 97 that is sized to be snugly received in the aperture 53 of the filter cartridge 48 and is coaxial with the axis al of the filter housing. Referring to FIGS. 6, 7, and 10, the housing cover 43 is generally shaped as an inverted cup with an upper end portion 101 having a drive portion 104 that may be configured as a hex or square drive, and is centrally located thereon. Joining the upper end portion 101 is the sidewall 110 of the housing cover including an upper sidewall portion 114 with an upper cylindrical exterior surface 116 with a circumferential upper seal groove 118 therein, a primary housing seal 120 in the upper seal groove, a mid sidewall portion 124 below the upper sidewall portion 114 with external threads 118 for engaging with the base threads 71, and a lower sidewall portion 122 with a lower cylindrical exterior surface 123 having a pair of circumferential lower seal grooves 126, 127. A respective pair of lower seals 130, 131 positioned in the lower seal grooves.

The lowest 127 of the lower seal grooves and the seal 131 therein are positioned to be axially below the third port 92 and third drain passageway 94 in the annular sump when the housing cover is fully in place. The upper 126 of the lower seal grooves and the seal 130 therein are positioned axially above the third drain passageway 94 when the housing cover 43 is fully in place.

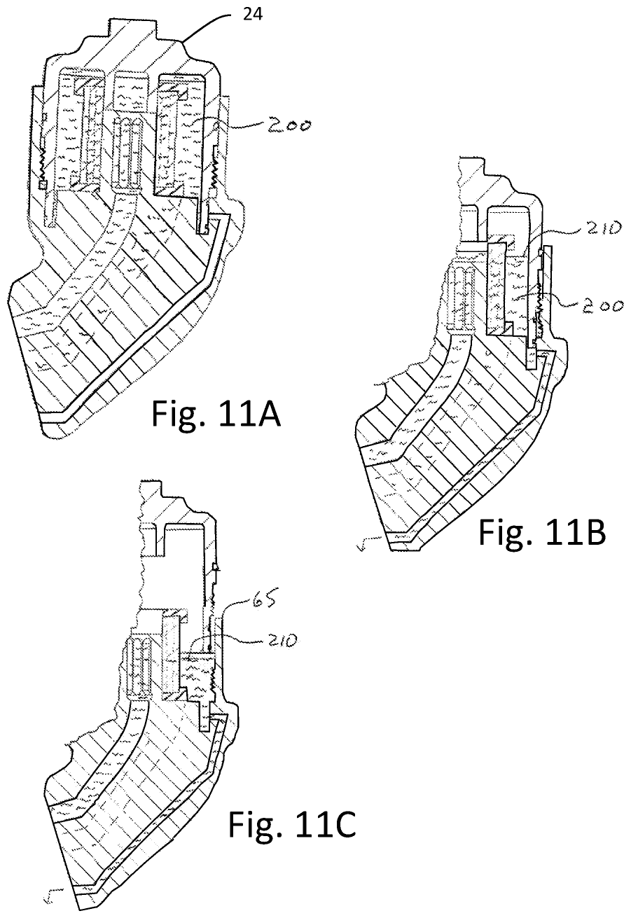

Referring to FIGS. 11A-11C the action of the noncirculating oil 200, as when the engine is not running, indicated by the wavy lines, is illustrated as the filter cover 43 is removed. FIG. 11A illustrates the noncirculating oil present in the filter cartridge 48, the recess 66, the base annular sump 76 when the engine is shut down. Even if the crankcase sump is drained oil may remain in the primary passages due to the oil pump acting as a stop and by generally non efficient crankcase draining. As the housing cover 43 is removed the oil level 210 drops as the third port 92 is opened and direct drainage may be provided to the crankcase sump. FIG. 11C illustrates the oil level significantly below the upper margin 65 of the base wall. The oil saturating the filter also may effective drain out the base sump and third port. Thus spillage upon removal of the housing cover and filter cartridge is minimized.

The oil filter housing may be formed of conventional metals such as steel and aluminum, or from various polymers and composites, including glass filled nylon. In embodiments, the filter housing assembly includes an attachment flange 26 that attaches to a cooperating surface 33 on the engine block and/or crankcase. In other embodiments, the lower portion of the base can be unitary with the crankcase of the engine.

Example of powersports equipment and engines suitable for use therein, and that are suitable for the inventions described herein are found in U.S. Pat. Nos. 6,796,395; 8,011,342; 8,167,072; 8,328,235; 8,651,214; 9,365,251; 10,294,889; 10,323,568; 11,110,994; US2016/0040561; US2019/0136721; and US2021/0271179. U.S. Pat. No. 5,698,098 discloses a filter system with a valve. All of the above patents and patent publications are incorporated herein by reference in their entirety for all purposes, except for express definitions and patent claims contained therein.

The invention is not restricted to the details of the foregoing embodiment (s). The invention extends to any novel one, or any novel combination, of the features disclosed in this specification (including any incorporated by reference references, any accompanying claims, abstract and drawings), or to any novel one, or any novel combination, of the steps of any method or process so disclosed. The above references in all sections of this application are herein incorporated by references in their entirety for all purposes.

While the aforementioned particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

I claim:

1. A filter housing comprising a base and cooperating housing cover that define a filter cartridge receiving region, wherein,
the base having an upper portion and a lower portion, the upper portion defining a central recess, the base having a pedestal having an upper pedestal surface and a filter cartridge receiving ported projection extending upwardly from the upper surface into the central recess, an annular sump extending downwardly from the central recess below the upper pedestal surface, the base having an inwardly facing cylindrical sealing surface at least partially defining the annular sump, a radially extending annular sump drainage port positioned in the cylindrical sealing surface; and
wherein the housing cover having a closed upper end and a downwardly extending annular wall sized to extend into the sump, the annular wall having a lower seal that, when the housing cover is fully seated with the base, a sealed closure is provided below the drainage port, the sealed closure precluding entry of oil into the drainage port;
whereby when the housing cover is raised upwardly, the lower seal is raised above the drainage port and oil in the filter housing may drain radially out the drainage port.

2. The filter housing of claim 1, wherein the housing cover has external threads that cooperate with internal threads of the base and wherein the lower seal on the annular wall is positioned on an exterior surface of the annular wall below the external threads.

3. The filter housing of claim 1, wherein the housing cover further has a primary seal positioned above the external threads, the primary seal engaging with an inwardly facing sealing surface of the base.

4. The filter housing of claim 1, wherein the housing cover has external threads that cooperate with internal threads of the base, the housing cover having a fully seated position on the base, and wherein the housing cover is fully seated, three annular seals connect between the filter housing cover and the base including the lower seal.

5. The filter housing of claim 4, wherein when a filter cartridge is in the filter housing and the filter housing cover is removed, the filter cartridge remains seated on the ported projection and the filter cartridge may be manually removed therefrom.

6. The filter housing of claim 1, wherein the annular sump has a bottom surface and wherein the oil drainage port is positioned above the bottom surface and the annular cylindrical sealing surface is positioned between the oil drainage port and the bottom surface.

7. The filter housing of claim 6, wherein the annular sump is visible and manually accessible for cleaning when the filter cover is removed.

8. A filter housing for an off road vehicle engine, the engine having an interface for the filter housing and a crankcase oil sump at a bottom of the engine, the interface positioned above the crankcase oil sump, the filter housing comprising a filter housing base and cooperating housing cover that when the housing cover is fully seated on the base define an oil circulating region and that captures a replaceable oil filter cartridge therein;
wherein the base having a pair of primary oil circulation ports for circulating oil through the filter and oil circulating region when the engine is running and further have an oil drainage port that is sealingly separated from the oil circulating region by an annular radially compressed seal in a circumferential groove on the housing cover when the filter housing cover is fully seated on the base; and
wherein when the housing cover is partially removed upwardly from the base, the annular radial seal is moved to a non blocking position whereby oil in the oil circulating region may enter the oil drainage port to be drained by gravity to the crankcase oil sump.

9. The filter housing of claim 8, wherein the oil drainage port is positioned in an annular sump in the filter housing base.

10. The filter housing of claim 9, wherein the annular sump defines a pedestal with an upwardly facing oil filter cartridge engaging surface.

11. The filter housing of claim 9 wherein the filter cartridge is spool shaped with two end caps with filter media therebetween and an axially extending aperture extending therethrough, and wherein the pedestal has a upward ported projection extending therefrom that is conformingly sized to the axially extending aperture and is insertable therein.

12. The filter housing of claim 11, wherein the housing cover has a downward central projection sized to the axially extending aperture of the filter cartridge and is insertable therein.

13. The filter housing of claim 11, in combination with the filter cartridge and in combination with the off road vehicle engine.

14. A filter housing for an off road vehicle engine, the engine having an interface for the filter housing and a crankcase oil sump at a bottom of the engine, the interface positioned above the crankcase oil sump, the filter housing comprising:
a filter housing base and
a cooperating housing cover,
the filter housing base having a annular wall defining a central recess that receives an oil filter cartridge and receives the cooperating housing cover, the housing cover seatable therein defining an oil circulating region, the central recess extending to a annular sump with an oil drainage port positioned therein, the oil drainage port sealingly blocked from the oil circulating region when the housing cover is fully seated in the base by a lower annular seal that extends between the inner surface of the annular wall and the outer surface of the housing cover, wherein when the housing cover is unseated the annular seal moves to a non blocking position allowing oil in the oil circulating region to flow to the oil drainage port.

15. The filter housing of claim 14, wherein the annular sump defines a pedestal with an upwardly facing oil filter cartridge engaging surface defined on the pedestal.

16. The filter housing of claim 15, wherein the filter cartridge is spool shaped with two end caps with filter media therebetween and an axially extending aperture extending therethrough, and wherein the pedestal has a upward ported projection extending therefrom that is conformingly sized to the axially extending aperture and is insertable therein.

17. The filter housing of claim 16, wherein the housing cover has a downward central projection sized to the axially extending aperture of the filter cartridge and is insertable therein.

18. The filter housing of claim 16, wherein the filter base has a first primary oil circulating passageway that connects to the upward ported projection and a second primary oil circulating passageway that has a second primary oil port on the pedestal base radially outward from the oil filter cartridge engaging surface.

19. The filter housing of claim 14, wherein the filter housing cover has a lowermost annular groove that receives the lower annular seal defined on the outer surface of said housing cover, the filter housing cover having exterior threads that cooperate with interior threads on the filter housing base, the annular groove and annular seal positioned below the exterior threads.

20. The filter housing of claim 19, wherein when the housing cover is fully seated the lower annular seal is positioned below the oil drainage port in the annular sump and wherein the filter housing cover comprises another annular groove with an annular seal therein positioned above the oil drainage port.
